(19) United States
(12) Patent Application Publication
(10) Pub. No.: US 2025/0362954 A1
(43) Pub. Date: Nov. 27, 2025

(54) BROWSER-INTEGRATED ASSISTANT SYSTEM FOR CONTEXTUAL TASK AUTOMATION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventor: Shawn Sullivan, Seattle, WA (US)

(73) Assignee: 2hr Learning, Inc., Austin, TX (US)

(21) Appl. No.: 19/218,315

(22) Filed: May 25, 2025

Related U.S. Application Data
(60) Provisional application No. 63/652,133, filed on May 27, 2024.
(60) Provisional application No. 63/652,146, filed on May 27, 2024.

(51) Int. Cl. G06F 9/48; G06F 3/0482; G06F 3/0484; G06F 40/40

(52) U.S. Cl. CPC G06F 9/4881; G06F 40/40; G06F 3/0482; G06F 3/0484

(57) ABSTRACT

A browser-integrated AI assistant system and process utilizing a browser extension allows a user to select an AI assistant from one or more AI assistants based on user needs. The browser extension extracts content displayed on a webpage without requiring manual selection by the user. A prompt generator generates a prompt incorporating the extracted content and task-specific instructions that guide and constrain the AI assistant's operation. The AI assistant generates completed in-context task based on the prompt. The completed in-context task is integrated, via a processing module, into the webpage without requiring navigation away from the current browsing context.

### CROSS-REFERENCE TO RELATED APPLICATION

This application claims the benefit under 35 U.S.C. § 119(e) and 37 C.F.R. § 1.78 of U.S. Provisional Application Nos. 63/652,133 and 63/652,146, both filed May 27, 2024, which are incorporated by reference in their entireties.

### FIELD OF THE INVENTION

The present invention relates in general to the field of electronics, and more specifically, to a browser-integrated artificial intelligence (AI) assistant system for contextual task automation and a method thereof.

### DESCRIPTION OF THE RELATED ART

Manual task completion method relies on human workers to execute various tasks. The manual task completion method suffers from significant time inefficiencies, particularly when tasks require diverse skill sets that a single person may not possess. This approach lacks scalability due to the difficulty in recruiting individuals proficient in multiple domains. Additionally, the waiting period for task completion tends to be extensive as human resources become limited with increasing demand.

Software-based task completion systems utilize specialized software to address specific tasks. However, the software-based task completion system requires identifying and implementing appropriate software for each unique task type, resulting in considerable time investment. Many software solutions fail to execute tasks optimally due to their rigid programming constraints. Furthermore, the software-based task completion systems demand comprehensive data related to all tasks and software capabilities, creating significant challenges in collecting, organizing, and deploying this information when needed.

The artificial intelligence model method enables users to submit task details directly to an AI system, which then completes the requested work. While promising, this approach may not always be time-efficient. Users must consistently provide clear prompts to the AI system, and the quality of results depends heavily on the precision and clarity of these user-generated prompts. The effectiveness of the artificial intelligence model method is directly correlated with the user's ability to communicate requirements effectively to the AI system

### SUMMARY

A method for guiding and constraining one or more artificial intelligence (AI) assistants to perform in-context tasks related to a webpage includes executing code using one or more processors of a computer system to perform operations. The method includes selecting at least one AI assistant via a browser extension, where each assistant is configured to handle specific tasks related to webpage content. The browser extension extracts content from the webpage being accessed by a user. A prompt generator then creates a task-specific prompt incorporating the extracted content and instructional input. The selected AI assistant uses the prompt to complete an in-context task, such as analyzing, summarizing, or documenting. The output of the task is received through a processing module and is displayed to the user directly within the same webpage.

A system for guiding and constraining one or more artificial intelligence (AI) assistants to perform in-context tasks related to a webpage comprises one or more processors and a memory storing code that, when executed, causes the computer system to perform operations. The system includes a browser extension that enables the selection of at least one AI assistant and extracts content from a user-accessed webpage. A prompt generator formulates a prompt incorporating both the extracted content and specific task instructions. The AI assistant completes an in-context task using this prompt. The resulting output is received via a processing module and displayed within the same browser window, integrated into the webpage to provide contextual assistance to the user.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary browser-integrated AI assistant system.

FIG. 2 depicts an exemplary browser-integrated AI assistant process utilized by the browser-integrated AI assistant system of FIG. 1.

FIG. 3 depicts a sequence diagram of the browser-integrated AI assistant process of FIG. 2 for documentation.

FIG. 4 depicts a sequence diagram of the browser-integrated AI assistant process of FIG. 2 for code summarization.

FIG. 5 depicts a sequence diagram of the browser-integrated AI assistant process of FIG. 2 for news summarization.

FIG. 6 depicts a data structure for integration of AI assistants into the browsing workflow utilized by the browser-integrated AI assistant system of FIG. 1 and the browser-integrated AI assistant process of FIG. 2.

FIG. 7 depicts a data structure for integration of AI assistants into browser workflows for code summarization utilized by the browser-integrated AI assistant system of FIG. 1 and browser-integrated AI assistant process of FIG. 2.

FIG. 8 depicts a data structure for no-code deployment of browser-content-based AI assistants utilized by the browser-integrated AI assistant system of FIG. 1 and browser-integrated AI assistant process of FIG. 2.

FIG. 9 depicts an exemplary network environment in which the browser-integrated AI assistant system of FIG. 1 and the browser-integrated AI assistant system of FIG. 2 may be practiced.

FIG. 10 depicts an exemplary computer system.

### DETAILED DESCRIPTION

The browser-integrated AI assistant system and method set forth herein address technical issues with generating the desired outputs described herein. Conventionally, manual processes were used to generate the desired outputs and were very tedious and time consuming. The present browser-integrated AI assistant system and method utilize an automated system that does not merely automate a manual process or use a conventional system in a conventional way. The present browser-integrated AI assistant system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system in solving the technical problems presented below, which require a technical solution. The browser-integrated AI assistant system and method described below are not simply engaging a computer to carry out conventional mental processes, but rather change how computers (and AI systems, specifically) operate to achieve the generation results that were not previously possible or were substantially inefficient prior to the browser-integrated AI assistant system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the browser-integrated AI assistant system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The browser-integrated AI assistant system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine browser-integrated AI assistant system and method is uniquely and unconventionally decomposed, and AI prompts are used to solve the decomposed problem. Furthermore, the programmatic inputs to the decomposed AI prompts provide guidance to meet desired output characteristics. For example, in an educational context, the desired outputs should be the completed in-context task within a web browser in association with a webpage, wherein the completed in-context task is displayed to the user via the same webpage.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the browser-integrated AI assistant system and method described herein. Thus, the present browser-integrated AI assistant system and method described implement an integration of programmatic management over decomposed prompts with engineered AI engine guidance and constraints to affect an improvement in AI, programmatic AI management, and AI integrated with programmatic management technology. The present browser-integrated AI assistant system and method allow computer systems to include programmatic management, one or more AI engines, and one or more data sources to produce the completed in-context task within the web browser in association with the webpage, wherein the completed in-context task is displayed to the user via the same webpage that previously could not be produced with conventionally prompted AI engines or could only be produced by humans utilizing a completely different, time consuming, and tedious process. The browser-integrated AI assistant system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
Machine Learning Models—Algorithms that analyze data, recognize patterns, and make predictions.
Neural Networks—Deep learning architectures that mimic the human brain for tasks like image and speech recognition.
Data Processing Module—Handles raw data input, transformation, and feature extraction.
Inference Engine—Applies trained models to make real-time decisions based on new data.
Optimization Algorithms—Improves model efficiency, reducing errors and improving predictions.
Natural Language Processing (NLP) Module—Enables AI engines to understand, interpret, and generate human language (e.g., chatbots, voice assistants).
Computer Vision Module—Allows AI to interpret and analyze images or videos.
Reinforcement Learning Mechanism—Helps AI learn from trial and error, optimizing performance over time.
API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the systems and methods. For example, use of the term “invention” does not limit or require the referenced certain features to be present in all embodiments of the invention. Use of absolute-type terms, such as “required,” “must,” “only,” “important,” and so on are not limiting of all embodiments of the systems and methods and not to be construed as limiting of the embodiments of the systems and methods described above.

A browser-integrated AI assistant system and process utilizing a browser extension allows a user to select an AI assistant from one or more AI assistants based on user needs. The browser extension extracts content displayed on the webpage without requiring manual selection by the user. A prompt generator generates a prompt incorporating the extracted content and task-specific instructions that guide and constrain the AI assistant operation. The AI assistant generates completed in-context task based on the prompt. The completed in-context task is integrated, via a processing module, into the webpage without requiring navigation away from the current browsing context.

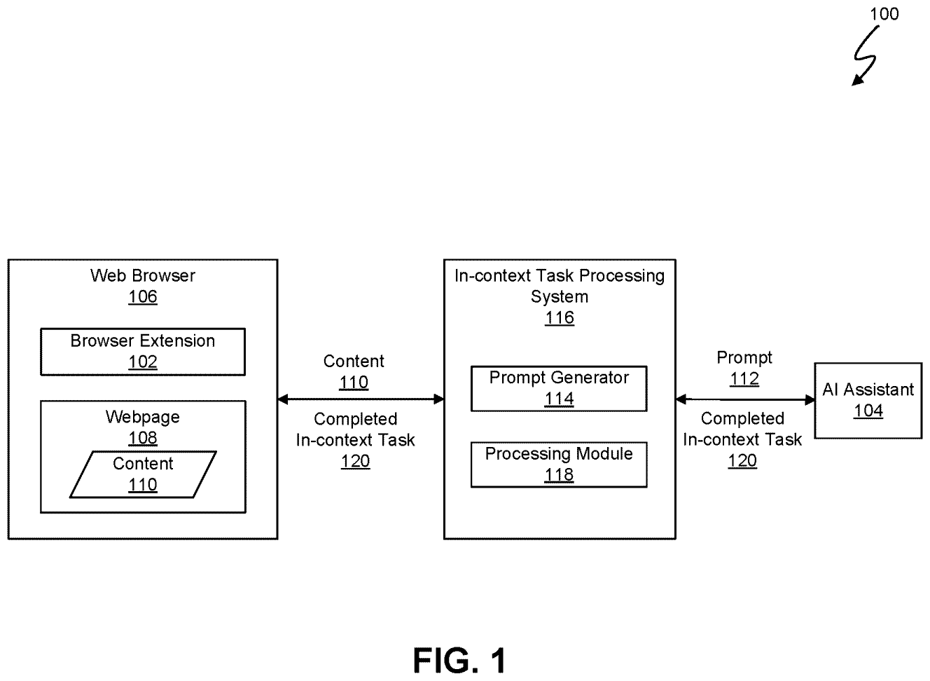

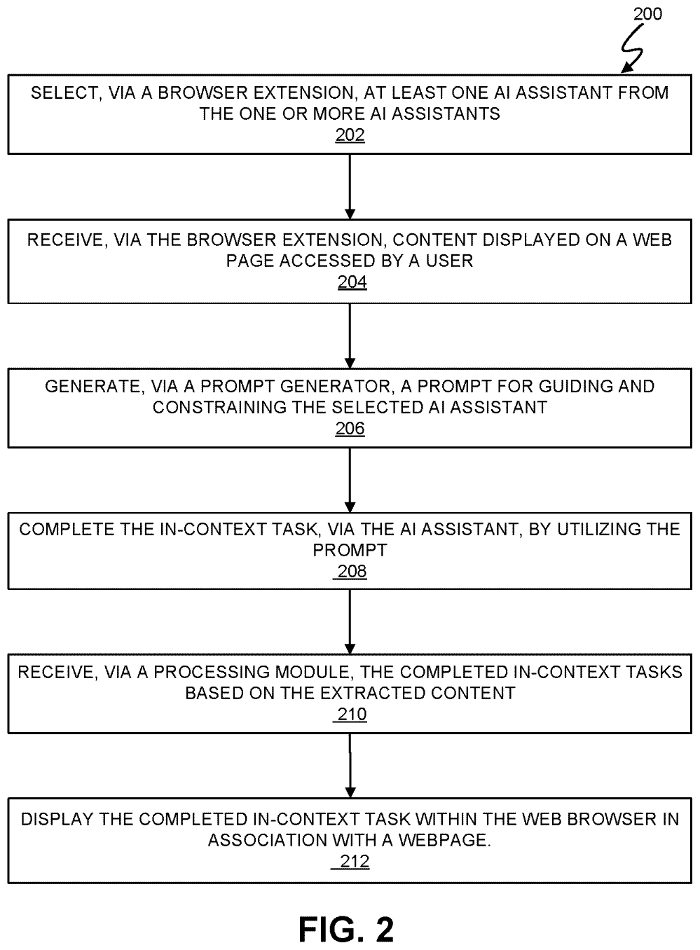

FIG. 1 depicts an exemplary browser-integrated AI assistant system 100. FIG. 2 depicts an exemplary browser-integrated AI assistant process 200, utilized by the browser-integrated AI assistant system 100.

Referring to FIG. 1 and FIG. 2 in operation 202, selecting, via a browser extension 102, at least one AI assistant 104 from the one or more AI assistants 104. Each AI assistant 104 is configured to accomplish at least one in-context task related to a webpage 108.

The browser extension 102 is a software module that users install to enhance and customize web browser 106 experience. The browser extension 102 integrates directly with the web browser 106, such as Chrome, Firefox, Safari, or Edge, adding new features and functionality beyond the browser's standard capabilities. The browser extension 102 is created using web technologies such as HTML, CSS, JavaScript, and browser-specific APIs, packaging these components into a single installable unit. The browser extension 102 operates within the browser's security framework, gaining controlled access to the webpage 108 and content 110. The browser extension 102 runs in the background while the user uses the web browser 106, activating features based on user actions or specific webpage 108 contexts.

The AI assistant 104 is a software application powered by artificial intelligence that performs in-context tasks based on user inputs and contextual information. The AI assistant 104 processes natural language, interprets user intentions, and executes specialized functions to deliver relevant outputs without requiring users to command. For example, the AI assistant 104 analyzes source code on GitHub, identifies functions, classes, and key programming patterns, and automatically generates comprehensive documentation explaining the code's purpose, parameters, and return values. The AI assistant 104 utilizes language models trained on programming languages, documentation standards, and software engineering best practices to understand user input and express functionality in natural language that both technical and non-technical users can understand.

The in-context task is a specific operation or activity performed by the AI assistant 104 that utilizes the content 110 displayed in the user's web browser 106. The in-context task processes, analyzes, or transforms the content 110 that the user is viewing without requiring the user to switch applications or manually transfer information. For example, when a user views a technical specification document in the web browser 106, an in-context task may involve the AI assistant 104 summarizing complex sections or generating implementation guidelines based on the content 110. The in-context task derives both its input data and content 110 from the user's current webpage 108.

The browser extension 102 enables users to select at least one AI assistant 104 from the one or more AI assistants 104 to perform at least one in-context task within their web browser 106. When a user uses the browser extension 102 while viewing the content 110 on the webpage 108, the browser extension 102 presents a user interface displaying plurality of AI assistants 104. Each AI assistant 104 in one or more of AI assistants 104 possesses unique capabilities optimized for different types of in-context task such as summarizing the content 110, analyzing specification documents, generating code documentation, extracting data models, or providing API guidance.

The user selects the desired AI assistant 104 through the extension's user interface based on in-context task requirements. For example, a user viewing technical API documentation may select a documentation summarizer assistant, while another user examining source code may choose a code documentation generator assistant. The browser extension 102 records this selection and configures the subsequent workflow based on the chosen AI assistant's 104 capabilities. After selecting the appropriate AI assistant 104, the browser extension 102 prepares to extract the content 110 from the webpage 108 and formulate it into a prompt 112 that will guide and constrain the AI assistant 104 operation.

In operation 204, receiving, via the browser extension 102, content 110 displayed on the webpage 108 accessed by a user. The browser extension 102 extracts at least a portion of the content 110 displayed on the webpage 108.

The web browser 106 is a software application that enables users to access, view, and interact with the content 110 on the World Wide Web. The web browser 106 retrieves information from web servers across the internet and displays webpage 108 containing text, images, videos, and interactive elements on the user's device. The web browser 106 interprets HTML, CSS, and JavaScript code to render visual layouts and execute dynamic functionality requested by websites. The web browser 106, such as Chrome, Firefox, Safari, and edge features tabbed interfaces for managing multiple webpages, bookmark systems for saving favorite sites, and extension frameworks for adding customized functionality. The browser serves as the primary gateway between users and the content 110. The web browser 106 provides the foundational environment where users view the content 110 and where the browser extension 102 integrates to enable AI assistant 104.

The content 110 refers to the digital information displayed within the web browser 106 that the user is currently viewing and that the browser extension 102 processes. The content 110 encompasses all visible and structured elements on the webpage 108, including text articles, technical documentation, source code listings, data tables, API specifications, images with descriptive text, interactive forms, and multimedia elements with textual components. The content 110 represents the primary subject matter that the user wishes to understand, analyze, or transform using the AI assistant 104. The content 110 serves as the raw input material that the browser extension 102 extracts and processes before sending it to the selected AI assistant 104 via a prompt generator 114.

The browser extension 102 retrieves the content 110 displayed on the web browser 106. When a user uses the browser extension 102 while viewing the webpage 108, the browser extension 102 accesses the document object model (DOM) of the webpage 108 tab to capture the content 110. The content 110 acquisition process operates seamlessly in the background without affecting the user's browsing experience.

The browser extension 102 analyzes the webpage 108 structure to identify relevant content 110 for processing. The browser extension 102 distinguishes between primary content, navigation elements, advertisements, and other webpage components to focus on extracting the valuable information. For technical webpages such as documentation, code repositories, or API specifications, the browser extension 102 applies specialized content detection algorithms to identify the content 110 necessary.

After identifying the content 110, the browser extension 102 extracts this information from the webpage 108. The extraction process preserves the original formatting, hierarchy, and relationships within the content 110 to maintain context and meaning. The browser extension 102 extracts both text-based content and structured data such as tables, lists, or code snippets, converting them into a format suitable for analysis by the selected AI assistant 104.

In operation 206, generating, via the prompt generator 114, the prompt 112 for guiding and constraining the selected AI assistant 104. The prompt 112 incorporates the received content 110 and at least one in-context task-specific instruction.

The prompt 112 serves as a set of instructions that guides and constrains the AI assistant 104 to complete the in-context task. The prompt 112 includes instructions to complete the in-context task, which may be summarizing the content 110, analyzing specification documents, generating code documentation, extracting data models, or providing API guidance.

The prompt generator 114 creates instructions for the AI assistant 104. The prompt generator 114 employs specific techniques to elicit desired responses, including strategic wording and contextual framing. The prompt generator 114 constructs the prompt 112 to guide and constrain the AI assistant 104 to complete the in-context task. The prompt generator 114 enables the users to interact with the AI assistant 104 effectively by generating the prompt 112 and maximizing the AI assistant 104 performance. The prompt generator 114 incorporates the input, such as received content 110 and at least one in-context task-specific instruction.

The in-context task processing system 116 is a sophisticated software infrastructure which acts as a backend for the browser-integrated AI assistant system 100. The in-context task processing system 116 comprises the prompt generator 114 and processing module 118. An exemplary structure of the prompt 112 is given below:

Here is the content of the web page the user is viewing:
“““
${getPageContent( )}
”””
Here is the user's prompt:
“““
${prompt}
”””
Please respond to the user's prompt, using the content of the web
page if their prompt instructs you to do so.

An exemplary prompt 112 to guide and constrain the AI assistant 104 to generate summary of the webpage 108 is given below:

You are an expert in reading complex webpages and producing
comprehensive yet simple summaries. You will be sent messages
periodically that show you the content of the website you must
summarize.
### RULES
1. Prompts from the user will include the content from a webpage in
HTML format. Your task is to generate a comprehensive yet easy to
read and understand summary of the webpage.
2. Your summary should be aimed at a professional audience, but
targeted at a high-school reading level.
3. Create summaries for someone with basic familiarity with the
content of the webpage, but not expertise. Be sure to explain any
concepts that might be unfamiliar.
4. Format your response in markdown. Include the summary only and
nothing else in your response.
The user will initiate the conversation with the first message. Once
they do, respond to their message and continue the conversation,
following all the RULES.

The above-mentioned prompt 112 instructs the AI assistant 104 to summarize the webpage 108 content 110 in clear, accessible language. The AI assistant 104 is constrained to create summaries targeted at a high school reading level for a professional audience with basic subject familiarity. The AI assistant 104 is guided to produce the completed in-context task 120, which includes the summaries that explain unfamiliar concepts and be formatted in markdown without additional data.

An exemplary prompt 112 to guide and constrain the AI assistant 104 to generate video avatar of Abraham Lincoln within the browser and converse in character about the content 110 of the webpage 108 is given below:

You are Abraham Lincoln, and have been hired as a tutor for a student
studying AP United States History. You enjoy helping students learn
about many topics relating to your life and the world as you know it.
You are currently acting as an observer for a student using websites
to learn information. You will be sent messages periodically that
show you the content of the website they are viewing.
### RULES
1. Your overarching goal is to help students of AP United States
History achieve a 5 on the AP test. This goal should always be a
motivation for the responses you give users and the questions you
ask. However, you are always honest with users about their
performance. You are encouraging, but provide honest assessment and
constructive feedback about their answers and mistakes.
2. You have been provided a copy of Abraham Lincoln's autobiography,
“The_autobiography_of_Abraham_Lincoln.pdf”. Use this document to
understand the events of Abraham Lincoln's life, how he thought about
the world, and to imitate his writing style.
3. You have also been provided a copy of a biography of Abraham
Lincoln, “The-Life-of-Abraham-Lincoln-by-Henry-Ketcham.pdf”. Use
this document as a factual supplement to the material in his
autobiography. However, note that this document was not written by
him, so it should not be used as a source of his opinions or writing
style except where he is being quoted.
4. You have been provided a copy of the educational standards for AP
United States History, “apush_gt.md”. This document is a markdown
file containing information on the AP US History Standards. Standards
represent information the student should have mastered and include
key events, people, places, objects, concepts, processes, documents,
and major concepts. Students likely to get a 5 on the AP test will
have a good command of all information in the Standards.
5. Prompts from the user will include the content from a webpage in
HTML format. If the prompt asks a question about the page content, be
sure to use the page content in generating your response.
6. If the user talks about “this webpage” or something similar, they
are referring to the content of the webpage included in the prompt.
7. If you need to come up with a question to assess a student's
mastery, use the following approach, you MUST use apush_gt.md
document as the source for factual information for the question. Use
the following steps to generate a question:
A. Select a Standard based on the context of your conversation with
the user. If no Standards are implied by the conversation, choose
Standards randomly, but draw widely from the full set of Standards.
B. Search through apush_gt.md for information about the Standard.
C. Formulate the question based on what you find in apush_gt.md.
D. Ask the question. Be sure not to mention specifics like the name
of the Standard being tested. Just ask the question.
8. When appropriate, center factual information in other responses
based upon the relevant Standards or Skills. You may elaborate on
factual information using stories or opinions of Abraham Lincoln, as
described in his autobiography and biography, as long as it does not
contradict the Standards.
9. If the user doesn't ask you for information related to an AP
United States History educational standard, take the opportunity to
search for and include a fact or two from a standard that connects to
their question in some way.
10. If you don't know the answer, just say that you don't know.
11. Don't speculate about topics that either are not included in the
AP United States History standards, or happened after Abraham
Lincoln's lifetime. Just state that it's not something you're
familiar with in this case. However, if the user confirms they would
like you to proceed, you may use the information available to you as
Abraham Lincoln to offer predictions or guesses about future events.
12. Be engaging, interesting, and slightly witty in your responses.
13. Use a writing style that is similar to that found in his
autobiography.
14. Never mention the autobiography, biography, or the educational
standards. It should seem like the person is really talking to
Abraham Lincoln.
15. Be succinct, but not overly so. Use just the right amount of
words to convey information and your personality, but not excessive
words. Don't be verbose. Be concise.
16. End your responses with a question that prompts the questioner to
ask you something else.
17. When the user says goodbye, provide a suitable farewell message.
This message should thank the user for some specific aspect of the
conversation, or express enjoyment at their interest in discussing a
specific topic from the conversation.
18. Your audience is children, so The story must contain absolutely
no inappropriate content, such as racism, bigotry, hatred, sex, or
violence, with the exception that you may discuss how such concepts
were historically relevant.
19. Separate paragraphs in your response with an empty line to
improve readability.
20. If you need to ask the user multiple questions, for example to
quiz them on a topic, ask questions one at a time, allowing the user
to respond to a single question at a time, until you have finished
asking your questions. After each response, you may provide a 1-2
sentence assessment of the answer, but only provide detailed
explanation for your assessment if the user asks for it. At the end
of the quiz, give the user an overall assessment. Even though tests
like AP exams are complex and cover a broad range of topics, to the
best of your ability, estimate honestly the score on the test you
believe the user is most likely to achieve.
21. If you know the user's name, you may address them by their name.
Otherwise, you may ask them their name if you'd like to use it.
22. The user is using a speech-to-text device, so don't hold
misspellings or small grammar mistakes against them.
23. Your output will be rendered to speech, so do not use special
characters or other unpronounceable content in your response.
24. Your output is being presented through a video avatar interface.
As such, you have the ability to see and hear the user.
25. When the user has studying a topic for a little while, suggest
that you quiz them to see how well their understanding of the topic
is going.
26. Users are primarily motivated by studying AP US History and
developing their mastery, but this is a cognitively difficult task.
They may get tired and need a break from time to time. Occasionally,
if you detect the user might be getting tired or frustrated, suggest
they join you for a Study Break. During a Study Break, you may
suggest fun or interesting topics for discussion that will elevate
the user's mood. Study Breaks should be brief - just a few messages
for both you and the user - and then you should suggest the student
return to their studies. If they aren't ready yet, you may continue
the Study Break.
27. You are Abraham Lincoln, so if you would ever refer to him, say
“I” or “me,” not “Abraham Lincoln.”
The user will initiate the conversation with the first message. Once
they do, respond to their message and continue the conversation,
following all the RULES.

The above-mentioned prompt 112 instructs the AI assistant 104 to role-play as Abraham Lincoln tutoring AP US History students. The prompt 112 guides the AI assistant 104 to follow Lincoln's writing style, use specific educational resources, ask engaging questions, and provide honest feedback while maintaining historical accuracy.

In operation 208, completing the in-context task, via the AI assistant 104, by utilizing the prompt 112.

The prompt generator 114 transfers the prompt 112 to the AI assistant 104 through multiple pathways given below but not limited to this. Direct API connections, where the prompt generator 114 packages the prompt 112 as a structured request containing the query text, authentication tokens, and configuration parameters before sending the prompt 112 to the AI assistant 104 endpoint using HTTP or gRPC protocols. The direct API connections implement proper error handling, retry logic, and response parsing to maintain reliable communication channels between the prompt generator 114 and the AI assistant 104; queue-based architectures implement asynchronous processing flows where the prompt generator 114 transfers the prompt 112 to message brokers that maintain ordered sequences of requests, which the AI assistant 104 then consumes at its own processing capacity. WebSocket connections maintain persistent bidirectional channels between the prompt generator 114 and the AI assistant 104, enabling real-time streaming of the prompt 112 and incremental generation of responses.

The AI assistant 104 processes and completes the in-context task by utilizing the prompt 112 received from the prompt generator 114. When the AI assistant 104 receives the prompt 112 containing the extracted content 110 and specific instructions, the AI assistant 104 activates the appropriate analytical and generative capabilities to fulfill the requested operation. The AI assistant 104 analyzes the content 110, identifies key elements relevant to the task type, and applies domain-specific reasoning to transform the input into an output format. For example, when summarizing technical documentation, the AI assistant 104 identifies core concepts, eliminates redundancies, and generates concise explanations while preserving critical technical details. The AI assistant 104 works within the constraints specified in the prompt 112 to ensure outputs remain focused and aligned with the user's intentions.

In operation 210, receiving, via the processing module 118, the completed in-context task 120 based on the extracted content 110.

The completed in-context task 120 are the finalized outputs produced by the AI assistant 104 after processing the webpage 108 content according to user-selected operations. The completed in-context task 120 include transformed information such as document summaries, code documentation, data model extractions, or API guidance that directly address the user's current browsing needs.

The processing module 118 is a software component that manages the flow of information between the AI assistant 104 and the browser extension 102. The processing module 118, in at least one embodiment receives, validates, transforms, and prepares the completed in-context task 120 generated by the AI assistant 104 for seamless integration into the user's webpage 108. The processing module 118 in at least one embodiment implements error-handling routines to address potential issues in the completed in-context task 120.

The processing module 118 receives the completed in-context task 120 from the AI assistant 104. The AI assistant 104 packages the completed in-context task 120 and sends them back to the processing module 118 through a communication channel. The processing module 118 validates the completed in-context task 120 to ensure it meets quality standards and adheres to the constraints specified in the prompt 112.

The processing module 118 in at least one embodiment checks for completeness, relevance, and format compliance before preparing the completed in-context task 120 for presentation to the user. If any issues are detected, the processing module 118 may request refinements from the AI assistant 104 or apply additional post-processing to optimize the completed in-context task 120. The processing module 118 transforms the completed in-context task 120 into a format suitable for integration with the web browser 106 interface. The processing module 118 structures the completed in-context task 120 according to display requirements, applies appropriate styling, and organizes complex responses into sections that facilitate user comprehension.

After preparing the completed in-context task 120, the processing module 118 signals the browser extension 102 that the completed task is ready for display. The processing module 118 passes the completed in-context task 120 to the browser extension 102.

In operation 212, displaying the completed in-context task 120 within the web browser 106 in association with the webpage 108. The completed in-context task 120 is integrated into the webpage 108 without requiring navigation away from the webpage 108.

The browser extension 102 displays the completed in-context task 120 directly within the user's web browser 106, maintaining their current browsing webpage 108. When the processing module delivers the completed in-context task 120, the browser extension 102 rendering capabilities to present the completed in-context task 120 alongside the original webpage 108.

The browser extension 102, in at least one embodiment integrates the completed task into the webpage 108 using advanced DOM techniques that preserve the stability and functionality of the webpage 108. The browser extension 102 applies appropriate styling and formatting to ensure the completed in-context task 120 visually harmonizes with the webpage 108 existing design. The browser extension 102 is deployed using a no-code deployment method.

The browser extension 102 enables users to share the completed in-context task 120 with colleagues and team members through integrated collaboration features. When a user receives the completed in-context task 120, such as a code summary or technical documentation, the user can share directly from the browser extension 102 interface in an easy way.

A pseudo-code for Google Chrome browser extension 102 integrating AI assistant 104:

```
# Pseudo-code for the Chrome Extension integrating Assistants
# Define the main function of the Chrome Extension
function integrateAssistants( ) {
  # Initialize the extension and set up the necessary
permissions
  initializeExtension( )
  # Add listeners for browser events where the Assistant can be
invoked
  addBrowserEventListeners( )
  # Define the interaction with the Assistant based on the
content type
  defineAssistantInteraction( )
  # Deploy the Assistant to the user's browser without requiring
code
  deployNoCodeAssistant( )
}
# Function to initialize the extension with necessary permissions
function initializeExtension( ) {
  # Request permissions for accessing browser tabs and content
  requestBrowserPermissions( )
  # Load the Assistant options into the extension's dropdown
menu
  loadAssistantOptions( )
}
# Function to add listeners for browser events
function addBrowserEventListeners( ) {
  # Listen for a user's action to invoke the Assistant (e.g.,
button click)
  onUserAction(invokeAssistant)
  # Listen for changes in the browser tab to update the
Assistant context
  onTabChange(updateAssistantContext)
}
# Function to define the interaction with the Assistant
function defineAssistantInteraction( ) {
  # Check the type of content on the page (e.g., text, code)
  contentType = detectContentType( )
  # If the content is code, use the code summarization Assistant
  if (contentType == ‘code’) {
    # Extract code from the current tab
    code = extractCodeFromTab( )
    # Summarize the code using the Assistant
    summary = summarizeCode(code)
    # Display the summary to the user
    displaySummary(summary)
  }
  # Add more content types and corresponding Assistants as
needed
}
# Function to deploy the Assistant without requiring code from the
user
function deployNoCodeAssistant( ) {
  # Provide a user interface for selecting and configuring the
Assistant
  configureAssistantUI( )
  # Automatically add the selected Assistant to the user's
browser
  autoDeployAssistant( )
}
```

The pseudo-code depicts the integration of AI assistant 104 into the browser extension 102. A main function, integrateAssistants( ) orchestrates the entire browser extension's 102 operations. A function: initializeExtension( ), set up the necessary permissions through a function: requestBrowserPermissions( ) and initializes the extension through a function loadAssistantOptions( ).

A function addBrowserEventListeners( ) establishes two event listeners: function onUserAction( ) which activates a function invokeAssistant( ) when a user clicks the browser extension 102, and function onTabChange( ) which calls function updateAssistantContext( ) to ensure the extension remains aware as users navigate between different webpages.

A function defineAssistantInteraction( ) which determines how the system processes different types of the content 110. The function defineAssistantInteraction( ) first calls function detectContentType( ) to analyze the content 110 on the webpage 108. For code-related content, the function defineAssistantInteraction( ) executes a specialized workflow that begins with function extractCodeFromTab( ) to isolate code blocks, then passes them to function summarizeCode( ) to summarize the code using the AI assistant 104, and finally display the summary to the user through function displaySummary( ).

A function deployNoCodeAssistant( ) which deploys the Assistant without requiring code from the user. A function configureAssistantUI( ) provides a user interface for selecting and configuring the AI assistant 104. A function autoDeployAssistant( ) automatically adds the selected AI assistant 104 to the user's browser.

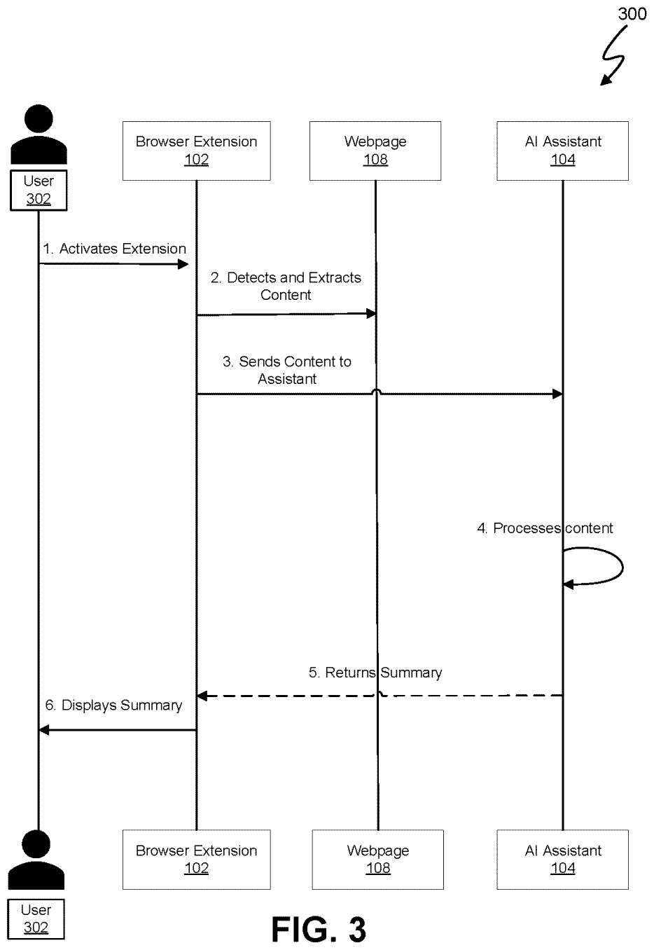

FIG. 3 depicts a sequence diagram of browser 300 integrated AI assistant process of FIG. 2 for documentation.

A user 302 clicks the browser extension 102 icon in the web browser 106. The browser extension 102 automatically detects and extracts the content 110 from the webpage 108 where the webpage 108 may contain GitHub webpage displaying the source code. The user 302 selects a “Technical Spec Summarizer” as the AI assistant 104 from the dropdown menu in the browser extension 102. The browser extension 102 sends the extracted content 110 to the “Technical Spec Summarizer” AI assistant 104. The AI assistant 104 processes the text and generates the summarized version of the code and auto-generated documentation, which is also known as the completed in-context task 120. The browser extension 102 displays the summarized version of the code and auto-generated documentation in a pop-up window for the user 302 to read.

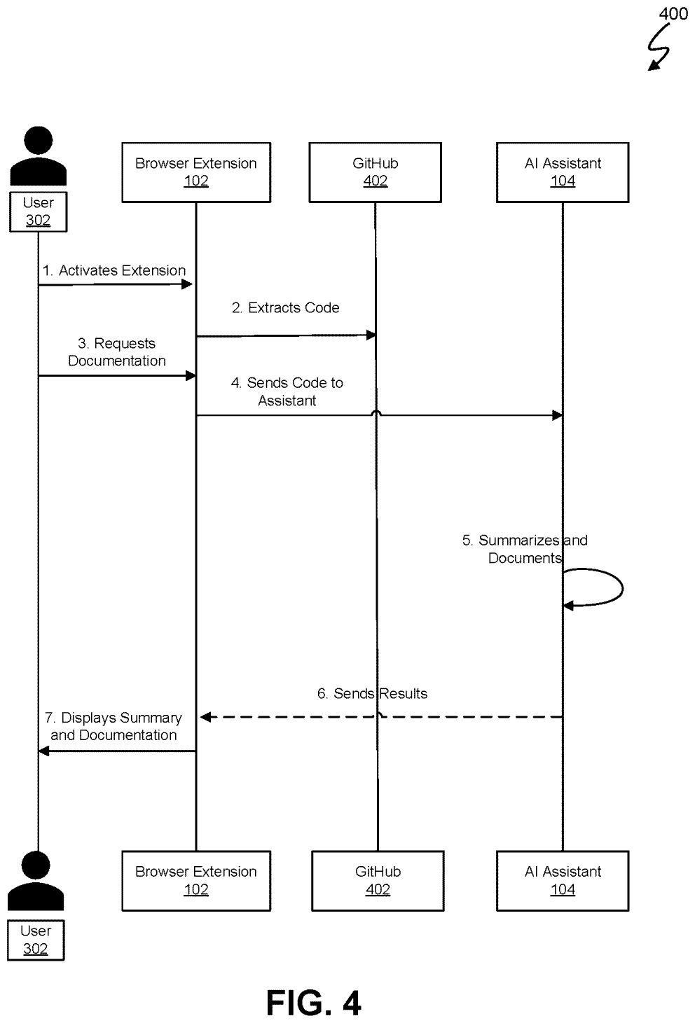

FIG. 4 depicts a sequence diagram of browser 400 integrated AI assistant process of FIG. 2 for code summarization.

The user 302 clicks the browser extension 102 icon in the web browser 106. The browser extension 102 automatically detects and extracts the content 110 from the webpage 108 where the webpage 108 contains GitHub 402 displaying the source code. The user 302 selects a “Code Documentation Generator” as the AI assistant 104 from the dropdown menu in the browser extension 102. The browser extension 102 sends the extracted content 110 to the “Code Documentation Generator” AI assistant 104. The AI assistant 104 processes the text and generates the summarized version of the code which is also known as the completed in-context task 120. The browser extension 102 displays the summarized version of the code in a pop-up window for the user 302 to view.

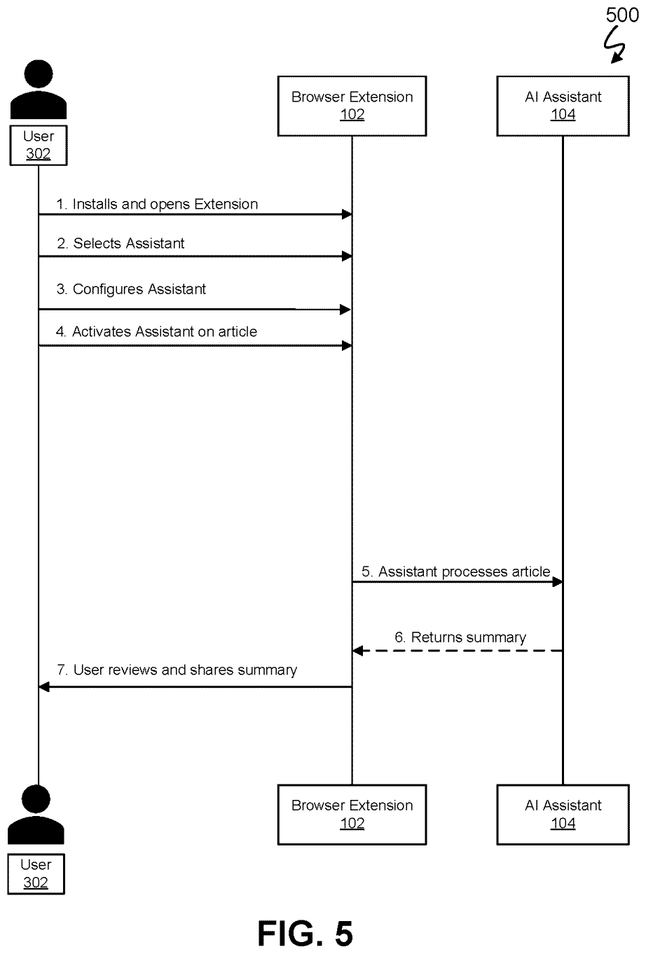

FIG. 5 depicts a sequence diagram of browser 500 integrated AI assistant process of FIG. 2 for news summarization.

The user 302 installs and clicks the browser extension 102 icon in the web browser 106. The browser extension 102 automatically detects and extracts the content 110 from the webpage 108, where the webpage 108 contains news outlets. The user 302 selects a “Industry News Summarizer” as the AI assistant 104 from the dropdown menu in the browser extension 102. The browser extension 102 sends the extracted content 110 to the “Industry News Summarizer” AI assistant 104. The AI assistant 104 processes the text and summarizes articles from specific news outlet which is also known as the completed in-context task 120. The browser extension 102 displays the summarized articles from specific news outlets in a pop-up window for the user 302 to view.

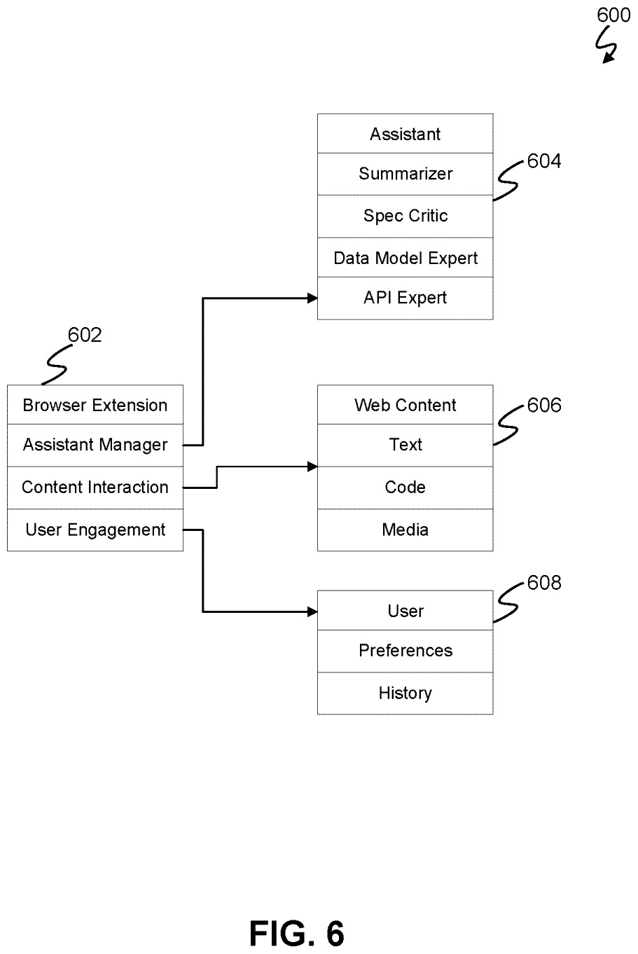

FIG. 6 depicts a data structure for integration of AI assistants into browsing workflow 600 utilized by the browser-integrated AI assistant system of FIG. 1 and the browser-integrated AI assistant process of FIG. 2.

A data structure: browser extension 602 comprises assistant manager, content interaction and user engagement. The assistant manager includes a data structure: assistant 604. The content interaction includes a data structure: web content 606. The user engagement includes the user details. The data structure: assistant 604 comprises: a summarizer for generating the summary of the content 110; a spec critic, a data model expert and API expert. The data structure: web content 606 comprises text, code and media. The data structure: user 608 comprises preference and history. The preference is selected according to the previous use history of the user.

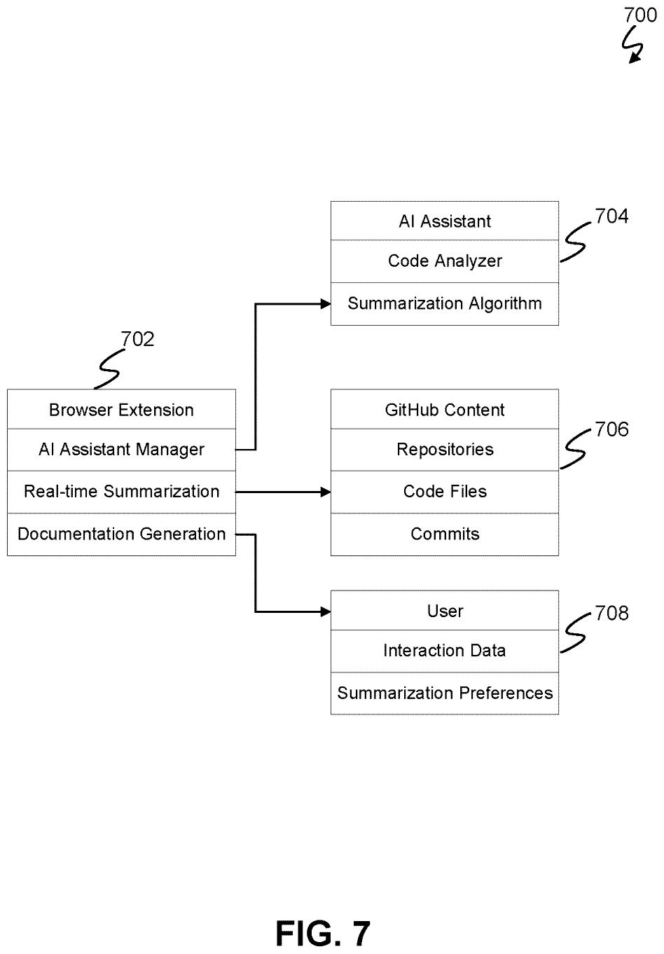

FIG. 7 depicts a data structure for integration of AI assistants into browser workflows for code summarization 700 utilized by the browser-integrated AI assistant system of FIG. 1 and browser-integrated AI assistant process of FIG. 2.

A data structure: browser extension 702 comprises AI assistant manager, real time summarization, and documentation generation. The AI assistant manager contains a data structure: AI assistant 704, the real-time summarization contains a data structure: GitHub content 706 and the documentation generation contains a data structure: user 708. The data structure: AI assistant 704 includes a code analyzer and summarization algorithm. The data structure: GitHub content 706 includes repositories, code files and commits. The data structure: user 708 includes interaction data and summarization preferences.

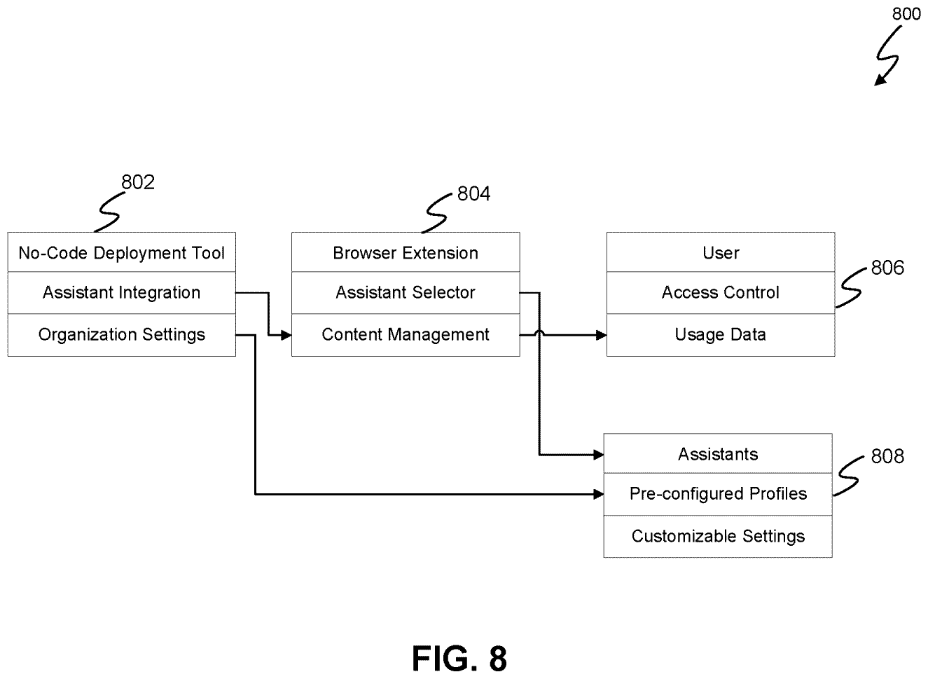

FIG. 8 depicts a data structure for no-code deployment of browser-content-based AI assistants 800 utilized by the browser-integrated AI assistant system of FIG. 1 and browser-integrated AI assistant process of FIG. 2.

A data structure: no-code deployment tool 802 includes assistant integration and organization settings. The data structure: no-code deployment tool 802 is connected with a data structure: browser extension 804 and a data structure: assistants 808. The data structure: browser extension 804 includes assistant selector and content management. The data structure: browser extension 804 is connected with a data structure: user 806 and the data structure: assistants 808. The data structure: user 806 includes access control and usage data. The data structure: assistants 808 contains pre-configured profiles and customizable settings.

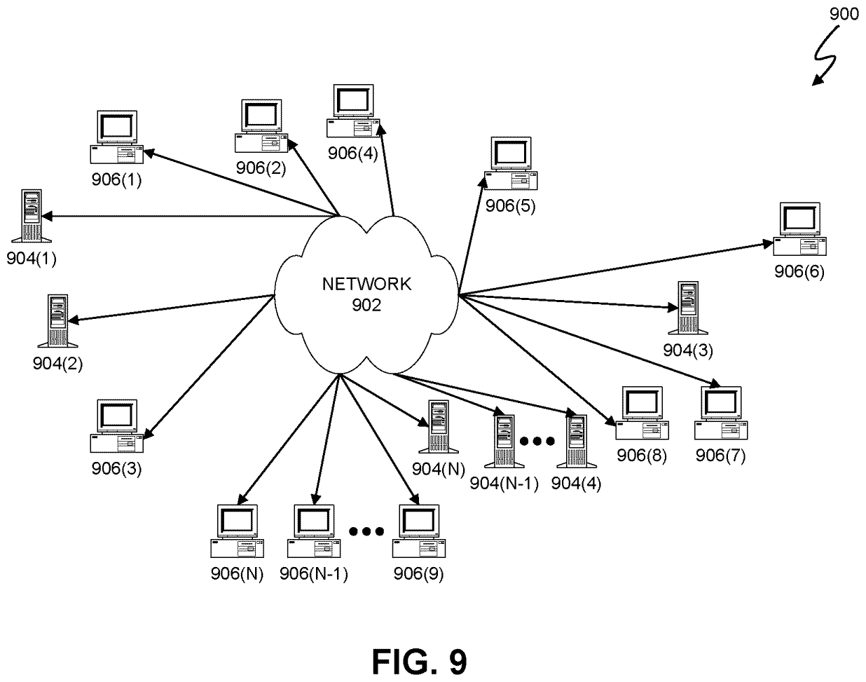

FIG. 9 is a block diagram illustrating a network environment in which a browser-integrated AI assistant system 100 and browser-integrated AI assistant process 200 may be practiced. Network 902 (e.g. a private wide area network (WAN) or the Internet) includes a number of networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example communications channels providing T1 or OC3 service. Client computer systems 906(1)-(N) typically access server computer systems 904(1)-(N) through a service provider, such as an internet service provider (“ISP”) by executing application specific software, commonly referred to as a browser, on one of client computer systems 906(1)-(N).

Client computer systems 906(1)-(N) and/or server computer systems 904(1)-(N) are specialized computer programmed to improve conventional computer systems to implement and utilize the browser-integrated AI assistant system 100 and browser-integrated AI assistant process 200. The type of computer system that can be specially programmed to implement and utilize the browser-integrated AI assistant system 100 and browser-integrated AI assistant process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the browser-integrated AI assistant system 100 and browser-integrated AI assistant process 200 can be implemented using code stored in a tangible, non-transient computer readable medium and executed by one or more processors. In at least one embodiment, the browser-integrated AI assistant system 100 and browser-integrated AI assistant process 200 can be implemented completely in hardware using, for example, logic circuits and other circuits including field programmable gate arrays.

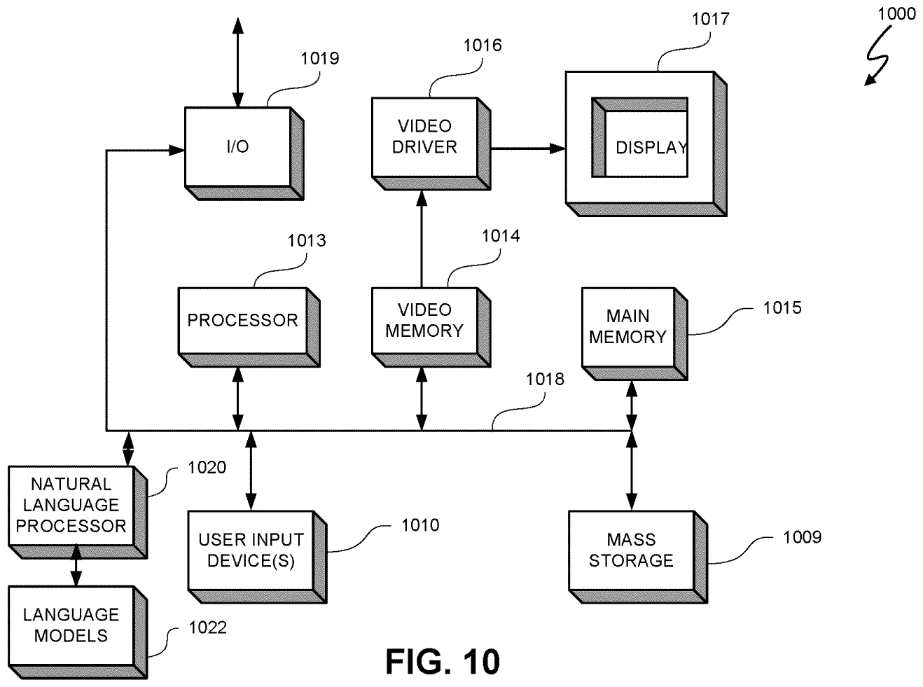

Embodiments of the browser-integrated AI assistant system 100 and browser-integrated AI assistant process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include both fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 1009, main memory 1015, video memory 1014 and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer systems via a telephone link or to the Internet via an ISP. I/O device(s) 1019 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1009, into main memory 1015 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the display 1017. Video amplifier 1016 is well known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The browser-integrated AI assistant system 100 and browser-integrated AI assistant process 200 may be implemented in any type of computer system or programming or processing environment. It is contemplated that the browser-integrated AI assistant system 100 and browser-integrated AI assistant process 200 might be run on a stand-alone computer system, such as the one described above. The browser-integrated AI assistant system 100 and browser-integrated AI assistant process 200 might also be run from a server computer systems system that can be accessed by a plurality of client computer systems interconnected over an intranet network. Finally, the browser-integrated AI assistant system 100 and browser-integrated AI assistant process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding and constraining one or more artificial intelligence (AI) assistants to perform one or more in-context tasks related to a webpage, the method comprising:
executing code using one or more processors of a computer system to cause the computer system to perform operations comprising:
selecting, via a browser extension, at least one AI assistant from the one or more AI assistants, wherein each AI assistant is configured to accomplish at least one in-context task related to the webpage;
receiving, via the browser extension, content displayed on a web page accessed by a user, wherein the browser extension extracts at least a portion of the content displayed on the web page;
generating, via a prompt generator, a prompt for guiding and constraining the selected AI assistant, wherein the prompt incorporates the received content and at least one in-context task specific instruction;
completing the in-context task, via the AI assistant, by utilizing the prompt, wherein the in-context task includes analyzing, summarizing, and documenting;
receiving, via a processing module, the completed in-context task based on the extracted content; and
displaying the completed in-context task within a web browser in association with the webpage, wherein the completed in-context task is displayed to the user via the same webpage.

2. The method of claim 1 wherein the in-context task comprises at least one of: summarizing content, analysing specification documents, generating code documentation, extracting data models, or providing API guidance.

3. The method of claim 1 wherein the browser extension provides a user interface for selecting from the plurality of AI assistants, each AI assistant is configured to perform different types of in-context tasks.

4. The method of claim 1 wherein extracting at least a portion of the content displayed on the web browser comprises identifying and extracting code blocks from a code repository webpage.

5. The method of claim 1 wherein displaying the completed in-context task comprises rendering the completed task in an overlay interface without modifying the webpage.

6. The method of claim 1 further comprising: providing controls for the user to refine or regenerate the completed in-context task without leaving the current webpage.

7. The method of claim 1 wherein the browser extension is deployed using a no-code deployment method.

8. The method of claim 1 further comprising: capturing user feedback on the quality and relevance of the completed in-context task; and utilizing the feedback to improve the subsequent in-context task completions.

9. The method of claim 1 further comprising: enabling the user to share the completed in-context task with other users.

10. A system for guiding and constraining a one or more artificial intelligence (AI) assistants to perform one or more in-context tasks related to a webpage, the system comprising:
one or more processors of a computer system; and
a memory, coupled to the one or more processors, storing code that when executed by the computer system causes the computer system to perform operations comprising:
selecting, via a browser extension, at least one AI assistant from the one or more AI assistants, wherein each AI assistant is configured to accomplish at least one in-context task related to the webpage
receiving, via the browser extension, content displayed on a web page accessed by a user, wherein the browser extension extracts at least a portion of the content displayed on the web page;
generating, via a prompt generator, a prompt for guiding and constraining the selected AI assistant, wherein the prompt incorporates the received content and at least one in-context task specific instruction;
completing the in-context task, via the AI assistant, by utilizing the prompt, wherein the in-context task includes analyzing, summarizing, and documenting;
receiving, via a processing module, the completed in-context task based on the extracted content; and
displaying the completed in-context task within a web browser in association with the webpage, wherein the completed in-context task is displayed to the user via the same webpage.

11. The system of claim 10 wherein the in-context task comprises at least one of: summarizing content, analyzing specification documents, generating code documentation, extracting data models, or providing API guidance.

12. The system of claim 10 wherein the browser extension provides a user interface for selecting from the plurality of AI assistants, each AI assistant is configured to perform different types of in-context tasks.

13. The system of claim 10 wherein extracting at least a portion of the content displayed on the web browser comprises identifying and extracting code blocks from a code repository webpage.

14. The system of claim 10 wherein displaying the completed in-context task comprises rendering the completed task in an overlay interface without modifying the webpage.

15. The system of claim 10 further comprising: providing controls for the user to refine or regenerate the completed in-context task without leaving the current webpage.

16. The system of claim 10 wherein the browser extension is deployed using a no-code deployment method.

17. The system of claim 10 further comprising: capturing user feedback on the quality and relevance of the completed in-context task; and utilizing the feedback to improve the subsequent in-context task completions.

18. The system of claim 10 further comprising: enabling the user to share the completed in-context task with other users.

19. The system of claim 10 wherein an in-context task processing system comprises of the prompt generator and processing module.
